(19) United States
(12) Patent Application Publication
(10) Pub. No.: US 2026/0219679 A1
(43) Pub. Date: Jul. 30, 2026

(54) AUTONOMOUS MOBILE ROBOT

(71) Applicant: SAMSUNG ELECTRONICS CO., LTD., Suwon-si (KR)

(72) Inventors: Changjoo NAM, Suwon-si (KR); Joonkyung KIM, Suwon-si (KR)

(73) Assignees: SAMSUNG ELECTRONICS CO., LTD., Suwon-si (KR); SOGANG UNIVERSITY RESEARCH & BUSINESS DEVELOPMENT FOUNDATION, Seoul (KR)

(21) Appl. No.: 19/306,484

(22) Filed: Aug. 21, 2025

(30) Foreign Application Priority Data
Jan. 24, 2025 (KR) 10-2025-0011954

(51) Int. Cl. G05D 1/646

(52) U.S. Cl. CPC G05D 1/646

(57) ABSTRACT

An autonomous mobile robot may include a storage unit configured to store data obtained while the autonomous mobile robot is being driven, at least one sensing unit configured to measure data including a distance value while the autonomous mobile robot is being driven, and a processor configured to control the autonomous mobile robot, where the processor may be configured to control the autonomous mobile robot to be driven according to a first mode in response to determining that an obstacle is recognized while the autonomous mobile robot is being driven, and control the autonomous mobile robot to move by being switched to a second mode in response to determining that the autonomous mobile robot is disposed adjacent to a local minimum, where the first mode and the second mode is controlled to switch by a rule-based switching method based on data measured by the sensing unit.

### CROSS-REFERENCE TO RELATED APPLICATION

This application claims priority to and the benefit of Korean Patent Application No. 10-2025-0011954 filed with the Korean Intellectual Property Office on Jan. 24, 2025, the entire contents of which is incorporated herein by reference.

### BACKGROUND OF THE INVENTION

### (a) Field of the Invention

The spirit and scope of the present disclosure relates to a robot device. More particularly, the present disclosure relates to an autonomous mobile robot.

### (b) Description of the Related Art

In diverse environments such as logistics, service, military, space, and smart factories, mobile robots providing autonomous driving services are increasing in number. In particular, the use of mobile robots is increasing as a technology for autonomous driving of multiple robots in environments where robot communication is impossible and there is no map.

In general, autonomous mobile robots, especially cooperative driving of multiple robots, are performed by first planning a collision-free path from the current robot position to each robot's destination, and then the controller generates control inputs so that the robots can drive along the path. Collisions between the obstacle or the robot may occur if the generated path is not correctly followed, e.g., during this process, due to environmental factors such as a control error of the robot, avoidance of a dynamic obstacle, or slipping of wheels.

In this way, when a collision between robots is expected, a collision-free path from the current state to the destination is re-generated, and the process of driving along the path is repeated. However, this technology has a problem in that the time required for path planning increases exponentially with the number of robots, making real-time re-planning difficult.

In addition to the method of driving by planning a route in advance, a method of driving while avoiding obstacles by generating control inputs in real time is being performed. Specifically, driving technologies such as Artificial Potential Field and Vector Field Histogram generate control inputs for the robot based on local sensor information to move the robot in a direction free of obstacles. However, since this technology utilizes locally available sensor information without considering the entire robot's driving path, it may fall into a local minimum and fail to complete the driving to the destination.

### SUMMARY OF THE INVENTION

The technical problem that the present disclosure seeks to solve is not only to predict collisions with obstacles, but also to solve the problem of a robot becoming stagnant due to falling into a local minimum in a nonconvex environment.

Another technical problem that the present disclosure seeks to solve is a problem that may arise when robots mistake other robots for fixed obstacles when communication between robots is limited.

An autonomous mobile robot may include a storage unit configured to store data obtained while the autonomous mobile robot is being driven, at least one sensing unit configured to measure data including a distance value while the autonomous mobile robot is being driven, and a processor configured to control the autonomous mobile robot, in which the processor may be configured to control the autonomous mobile robot to be driven according to a first mode in response to determining that an obstacle is recognized while the autonomous mobile robot is being driven, and control the autonomous mobile robot to move by switching from the first mode to a second mode in response to determining that the autonomous mobile robot is disposed adjacent to a local minimum, and a switching between the first mode and the second mode is controlled by a rule-based switching method based on data measured by the sensing unit.

An autonomous mobile robot may include a storage unit configured to store data obtained while the autonomous mobile robot is being driven, at least one sensing unit configured to measure data including a distance value and state information of the autonomous mobile robot while the autonomous mobile robot is being driven, and a processor configured to control the autonomous mobile robot, in which the processor may be configured to control the autonomous mobile robot to be driven according to a first mode in response to determining that an obstacle is recognized while the autonomous mobile robot is being driven, control the autonomous mobile robot to switch from the first mode to a second mode and exit the local minimum by moving along a wall in response to determining that the autonomous mobile robot operating in the first mode is disposed at a local minimum, and a switching between the first mode and the second mode is controlled by a learning-based switching method based on a pattern learned by using a vision transformer (ViT)-based neural network learned through expert demonstration data and data measured from the sensing unit.

An autonomous mobile robot may include a storage unit configured to store data obtained while the autonomous mobile robot is being driven, at least one sensing unit configured to measure data including a distance value while the autonomous mobile robot is being driven, and a processor configured to control the autonomous mobile robot, in which the processor may be configured to control the autonomous mobile robot to be driven according to a first mode in response to determining that an obstacle is recognized while the autonomous mobile robot is being driven, control the autonomous mobile robot to switch to a second mode and exit the local minimum by moving along a wall in response to determining that the autonomous mobile robot operating in the first mode is disposed adjacent to a local minimum, a switching between the first mode and the second mode is controlled by combining a rule-based switching method configured to determine whether a magnitude of the total force of the autonomous mobile robot is smaller than or equal to a threshold value based on data measured by the sensing unit and a learning-based switching method utilizing a pattern learned from a vision transformer (ViT)-based neural network model learned based on expert demonstration data, and the learning-based switching method is controlled to perform by replacing a value determined by the rule-based switching method in response to determining that another autonomous mobile robot is disposed around the autonomous mobile robot.

Since an autonomous mobile robot according to an embodiment of the present disclosure prevents the robot from falling into a local minimum in an environment with a nonconvex obstacle by switching the mode according to a rule-based switching method, the robot may smoothly reach the target point while improving the success rate of path searching.

By switching the mode according to a learning-based switching method, an autonomous mobile robot according to another embodiment of the present disclosure may minimize a path searching error occurring in the interaction between multiple robots and the efficiency of the path searching under the limited environment information may be improved.

Since an autonomous mobile robot according to still another embodiment of the present disclosure switches the mode by combining a rule-based switching method and a learning-based switching method, the high performance may be maintained without communication between robots, high usability may be provided even in an environment without a communication infrastructure, real-time path searching may be possible, the robot may be immediately adapted even in the dynamic environment of the robot, and the path searching efficiency and usability may be improved by not repeating the same path.

### BRIEF DESCRIPTION OF THE DRAWINGS

FIG. 1 is a block diagram of an autonomous mobile robot of according to an embodiment of the present disclosure.

FIG. 2 is a block diagram of an autonomous mobile robot of according to another embodiment of the present disclosure.

FIG. 3 is a block diagram for the driving procedure of an autonomous mobile robot of according to an embodiment of the present disclosure.

FIG. 4 is a block diagram for the driving procedure of an autonomous mobile robot of according to another embodiment of the present disclosure.

FIG. 5 and FIG. 6 are drawings for explaining an example of securing peripheral data of an autonomous mobile robot of according to an embodiment of the present disclosure.

FIGS. 7, 8 and 9 are flowcharts for a driving method of an autonomous mobile robot of according to an embodiment of the present disclosure, and FIG. 10 is a schematic view for the driving procedure of an autonomous mobile robot of according to an embodiment of the present disclosure.

FIG. 11 and FIG. 12 are flowcharts for a driving method of an autonomous mobile robot of according to another embodiment of the present disclosure, and FIG. 13 is a schematic view for the driving procedure of an autonomous mobile robot of according to another embodiment of the present disclosure.

FIG. 14 shows an actual implementation environment of an autonomous mobile robot of the present disclosure.

FIGS. 15, 16, 17 and 18 represent an environment for data collection for learning-based rule switching of an autonomous mobile robot of the present disclosure.

FIGS. 19, 20, 21, 22 and 23 represent a simulation experiment environment of an autonomous mobile robot of the present disclosure and an autonomous mobile robot of a Comparative Example.

FIGS. 24, 25, 26, 27 and 28 are result graphs according to the simulation experiment environment of FIG. 19 to FIG. 23.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

To clearly describe the present disclosure, parts that are irrelevant to the description are omitted, and like numerals refer to like or similar constituent elements throughout the specification.

Further, since sizes and thicknesses of constituent members shown in the accompanying drawings are arbitrarily given for better understanding and ease of description, the present disclosure is not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

It will be understood that when an element such as a layer, film, region, plate, etc. is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Further, throughout the specification, the phrase “in a plan view” means when an object portion is viewed from above, and the phrase “in a cross-sectional view” means when a cross-section taken by vertically cutting an object portion is viewed from the side.

Additionally, terms such as “ . . . part”, “ . . . device”, and “ . . . module” described in the specification perform at least one function or operation, and may be implemented by a hardware or a software, or by a combination of a hardware and a software. Additionally, a plurality of “ . . . module”, a plurality of “ . . . device”, or a plurality of “ . . . module” may be integrated into at least one module and implemented as at least one processor, except for “ . . . part”, “ . . . device”, and “ . . . module” that need to be implemented by a specific hardware.

In this specification, “transmitting” or “providing” may include not only directly transmitting or providing, but also indirectly transmitting or providing via another device or using a bypass path.

In the description, expressions described in the singular in this specification may be interpreted as the singular or plural unless an explicit expression such as “one” or “single” is used.

The present disclosure will be described more fully hereinafter, in which embodiments of the disclosure are shown. As those skilled in the art would realize, the described embodiments may be modified in various different ways, all without departing from the spirit or scope of the present disclosure.

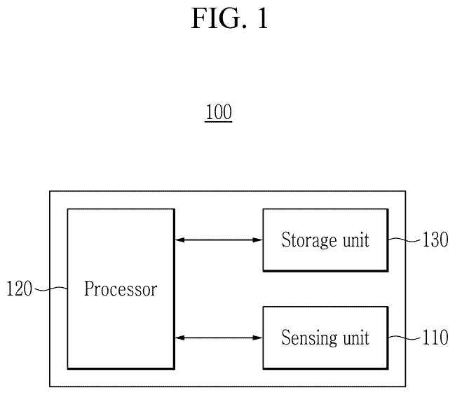

FIG. 1 is a block diagram of an autonomous mobile robot 100 of according to an embodiment of the present disclosure.

Referring to FIG. 1, the autonomous mobile robot 100 of the present disclosure may include a sensing unit 110, a processor 120, and a storage unit 130. The autonomous mobile robot 100 may autonomously drive while measuring a distance value by using the sensing unit 110, and when the autonomous mobile robot 100 is disposed adjacent to a local minimum, the problem of the autonomous mobile robot 100 being disposed at the local minimum and its movement restricted may be solved through switching between a plurality of modes by a rule-based switching method.

The local minimum means the case that the autonomous mobile robot 100 has reached a lowest point of an algorithm such as an artificial potential field. Specifically, the local minimum point is a point where the potential value only increases and does not decrease when moving in any adjacent direction from the current position of the robot, and when the autonomous robot (100) moves from that point to any other adjacent point, the potential value becomes higher, meaning that the robot is trapped.

Since at the local minimum, the autonomous mobile robot 100 has a lower potential at the position than moving to other surrounding positions, this means a situation of being unable to move.

The autonomous mobile robot 100 of the present disclosure switches the mode by the rule-based switching method so that the autonomous mobile robot 100 may autonomously avoid an obstacle and search a path, and thereby the problem of being disposed the local minimum and having its movement restricted may be solved.

The sensing unit 110 may measure the distance value while the autonomous mobile robot 100 is being driven. The distance value may measure a distance between the autonomous mobile robot 100 and surrounding objects. For example, the sensing unit 110 may detect the surrounding obstacles by an omni-directional distance sensor, and may assist the autonomous mobile robot 100 to reach a target point by utilizing distance information to the obstacle.

In an embodiment, the sensing unit 110 may further capture an image of surroundings of the autonomous mobile robot 100 while the autonomous mobile robot 100 is being driven. Specifically, the image of surroundings may be configured as a plurality of images or frames. For example, the sensing unit 110 may record information such as an external environment of the autonomous mobile robot 100 by using a member such as a camera.

In an embodiment, the sensing unit 110 may include a state measurement sensor configured to obtain information on the state of the autonomous mobile robot 100. State information of the robot may include estimated information on the current position of the robot, and may be sensed information such as a moving distance. Specifically, the state measurement sensor may obtain information at a particular location, for example, information such as a coordinate value while the robot is moving. The state measurement sensor obtains information at the particular location, and may prevent the autonomous mobile robot 100 from being repeatedly disposed on the same path.

In an embodiment, the sensing unit 110 may include a plurality of sensors including a distance sensor, an image sensor, or a state measurement sensor. For example, the sensing unit 110 may include an image sensor such as a camera or a thermal imaging camera, a global positioning system (GPS), an inertial measurement unit (IMU), a distance sensor such as a radar sensor, a lidar sensor, an odometry, an ultrasonic sensor, or an infrared sensor, and a state measurement sensor such as a gyroscope, an accelerometer, or a voltage and current sensor.

The GPS may be a sensor configured to estimate geographical position of the autonomous mobile robot 100. The GPS may include a transceiver configured to estimate the position of the autonomous mobile robot 100 with respect to the Earth.

The IMU may be a combination of sensors configured to detect changes in the position and orientation of the autonomous mobile robot 100 based on an inertial acceleration. For example, the IMU may include accelerometers or gyroscopes.

The radar sensor may be a sensor configured to detect objects within the environment where the autonomous mobile robot 100 is located by using a wireless signal. Specifically, the radar sensor may be configured to detect speeds and/or directions of objects.

The lidar sensor may be a sensor configured to detect objects within the environment in which the autonomous mobile robot 100 is located by using a laser. Specifically, the lidar sensor may include a laser light source configured to emit laser and/or a laser scanner and a detector configured to detect to the reflection of the laser. For example, the lidar sensor may be configured to operate in a coherent or incoherent detection mode.

The odometry may measure the moving distance of the robot and track the position change. For example, the odometry may be measured through a sensor attached to a wheel. The above ultrasonic sensor may measure distance by emitting sound waves and measuring the time it takes for them to reflect and return. The above infrared sensor may measure distance by emitting infrared light and detecting the reflected light.

The gyroscope may stably maintain its posture by detecting a rotation and direction switching of the autonomous mobile robot 100. The accelerometer may identify a speed change of the autonomous mobile robot 100 that is moving by measuring an acceleration of the autonomous mobile robot 100. The voltage and current sensor may monitor the battery state and power consumption of the autonomous mobile robot 100.

The processor 120 may control the autonomous mobile robot 100 overall.

Specifically, the processor 120 may control the autonomous mobile robot 100 to sense the distance value and an image or the state information of surroundings by using the sensing unit 110 while the autonomous mobile robot 100 is being driven.

When an obstacle is recognized while the autonomous mobile robot 100 is being driven, the processor 120 may be switched between the plurality of modes, thereby preventing the autonomous mobile robot 100 from being disposed at the local minimum. Specifically, the processor 120 may perform a control to switch between the plurality of modes by controlling the determined value based on a predetermined rule.

The storage unit 130 may store information obtained from the sensing unit 110 and the processor 120. As an unlimiting example, the storage unit 130 may include a magnetic disk drive, an optical disk drive, a flash memory. For example, the storage unit 130 may be a portable USB data storage device. The storage unit 130 may store a system software for executing examples related to an operation of the autonomous mobile robot 100.

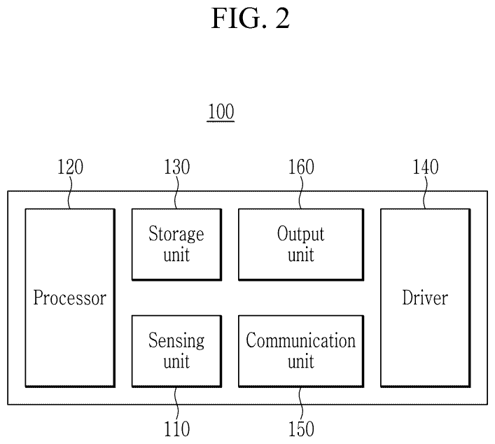

FIG. 2 is a block diagram of the autonomous mobile robot 100 of according to another embodiment of the present disclosure.

Referring to FIG. 2, the autonomous mobile robot 100 may include the sensing unit 110, the processor 120, the storage unit 130, a driver 140, a communication unit 150, and an output unit 160. The sensing unit 110, the processor 120, and the storage unit 130 are the same as the content of FIG. 1 described above to the extent that do not contradict each other.

The driver 140 may assist the movement of the autonomous mobile robot 100. The driver 140 may be controlled by the processor 120, and may be a member configured to drive the autonomous mobile robot 100 to move to the target point. As an unlimiting example, the driver 140 may be configured as a member such as a wheel or a rail to easily assist the movement of the autonomous mobile robot 100.

The communication unit 150 may control communication between configurations within the autonomous mobile robot 100, or include at least one antenna for wirelessly communicating with other devices. For example, the communication unit 150 may be used in order to wirelessly communicate with a cellular network or another wireless protocol and system through Wi-Fi or Bluetooth.

In an embodiment, the communication unit 150 may be controlled by the processor 120 and may be a hardware device implemented by various electronic circuits, e.g., processor, transceiver, etc., to transmit/receive wireless signals. For example, the processor 120 may execute a program included in the storage unit 130 in order for the communication unit 150 to transmit/receive wireless signals with a cellular network.

The output unit 160 may output an audio signal or a video signal. The output unit 160 may be controlled by the processor 120, and as an unlimiting example, may include an output member such as a display or an acoustic output unit.

The display may include a liquid crystal display, at least one of a thin film transistor liquid crystal display, an organic light emitting diode, a flexible display, a 3-dimensional display (3D Display), or an electrophoretic display. Depending on the implementation form of the output unit 160, the output unit 160 may include two or more displays.

The acoustic output unit may output audio data received from the communication unit 150 or stored in the storage unit 130. The acoustic output unit may include, for example, an output unit such as a speaker or a buzzer. The output unit 160 may include a network interface, and as an unlimiting example, may be implemented in the form of a touch screen.

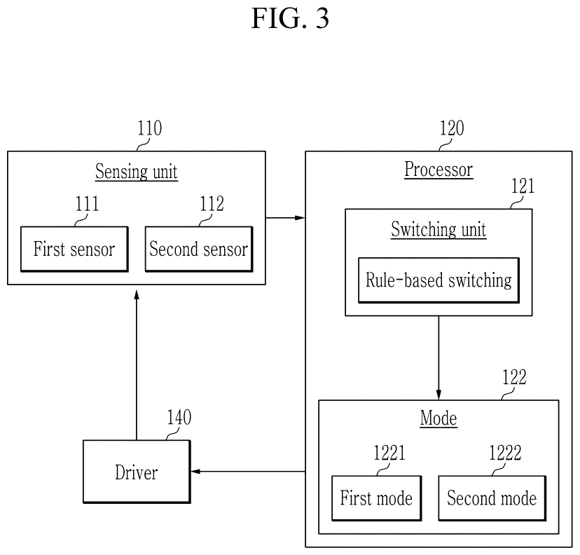

FIG. 3 is a block diagram for the driving procedure of the autonomous mobile robot 100 of according to an embodiment of the present disclosure.

Referring to FIG. 3, in an embodiment, the autonomous mobile robot 100 may switch the mode by the processor 120 based on the result data measured by the sensing unit 110, and may control the driver 140 to drive so as to avoid the obstacle. Specifically, the result data measured by the sensing unit 110 may be provided to the processor 120, and when the autonomous mobile robot 100 is disposed adjacent to the obstacle based on the data, the processor 120 may drive while switching a mode 122 by a switching unit 121, so that the robot 100 smoothly can reach the target point and the path searching efficiency and a success rate can be improved.

The sensing unit 110 may include a plurality of sensors. Specifically, the sensing unit 110 may include a first sensor 111 and a second sensor 112. More specifically, the sensing unit 110 may include the first sensor 111, which is a distance sensor configured to measure a distance, and the second sensor 112, which is the state measurement sensor configured to measure the state information of the autonomous mobile robot 100.

The first sensor 111 may be a distance sensor, for example, a lidar sensor. Specifically, the first sensor 111 may be an omni-directional distance sensor, disposed in upper portion of the autonomous mobile robot 100, and may perform 360° omni-directional distance measurement.

The second sensor 112 may be a state measurement sensor, and may measure the state information of the autonomous mobile robot 100. As an unlimiting example, the state information may measure a current position, a target position, a previous path record, information at mode switching, information before and after mode switching, or the like, of the autonomous mobile robot 100.

The processor 120 may include the switching unit 121 switching the mode 122 of the autonomous mobile robot 100. When the autonomous mobile robot 100 is disposed adjacent to the obstacle or the autonomous mobile robot 100 is disposed adjacent to the local minimum, the switching unit 121 may perform a control to avoid the obstacle while switching the mode 122, or to exit the local minimum.

When an obstacle is recognized while the autonomous mobile robot 100 is being driven, the processor 120 may perform a control to be driven by a first mode 1221. The first mode 1221 may be, for example, at least one of approaches using an artificial potential field (APF), a vector field histogram (VFH), a dynamic window approach (DWA), a Follow the Gap algorithm, or an artificial neural network. More specifically, the first mode 1221 may be the artificial potential field. The artificial potential field may be a reactive planning method for the autonomous mobile robot 100 to reach the target while avoiding the obstacle.

The artificial potential field may determine a subsequent moving direction by using relative position vectors from the autonomous mobile robot 100 to the obstacles by using a values measured by the sensing unit 110. Specifically, the artificial potential field may use a value of a total force vector determined by an Equation below.

$${F}_{tot} = w {F}_{att} + ( 1 - w ) {F}_{rot} , 0 \leq w \leq 1 . \qquad < Equation >$$

A total force vector Fₜₒₜ calculated in the artificial potential field may be calculated as a weighted sum of an attractive force Fₐₜₜ and a repulsive force Fᵣₒₜ. The attractive force is a force attracting the autonomous mobile robot 100 from the target point, and may become gradually stronger as the autonomous mobile robot 100 becomes closer to the target point. This may induce the autonomous mobile robot 100 to move along the target point. The attractive force may be calculated in proportion to a distance from the target point to a current the autonomous mobile robot 100, i.e., a relative position value.

The repulsive force is a force that moves the autonomous mobile robot 100 away from the obstacle to avoid collision with the obstacle, and may become stronger as the autonomous mobile robot 100 comes closer to obstacle. This may contribute to prevent the autonomous mobile robot 100 from the collision with the obstacle. The repulsive force may be calculated inversely proportional to a relative position value with respect to the surrounding obstacles.

When the autonomous mobile robot 100 moves while the vector values of the attractive force and the repulsive force described above are balanced, the first mode 1221 has a problem of falling into the local minimum, and this problem may occur further frequently in an environment with a nonconvex obstacle. This means that vector values of the attractive force and the repulsive force are balanced so that a magnitude of the total force vector becomes small to be close to 0. In this case, a problem may occur in that the autonomous mobile robot 100 cannot find a subsequent moving direction, and becomes stuck to be unable to move any more toward the target point.

In an embodiment, when the autonomous mobile robot 100 is disposed adjacent to the local minimum or has fallen into the local minimum, the processor may move by being switched to a second mode 1222. Specifically, in order to solve the problem of the first mode 1221, when the autonomous mobile robot 100 is disposed adjacent to the local minimum, the processor may be switched to the second mode 1222. When the autonomous mobile robot 100 is disposed adjacent to the local minimum or has fallen into the local minimum, the second mode 1222 may exit the local minimum by moving along the obstacle.

The second mode 1222 may be, for example, a wall-following mode. Specifically, when the autonomous mobile robot 100 is disposed adjacent to the local minimum or has fallen into the local minimum while driving in the first mode 1221, the wall-following mode may exit the local minimum.

The wall-following mode may control the autonomous mobile robot 100 to move along a wall of the obstacle. Specifically, a control may be performed to move along a boundary or edge of the obstacle. More specifically, the wall-following mode may perform a control so that an autonomous driving mode 100 may move clockwise or counterclockwise along the obstacle.

In an embodiment, the first mode 1221 and the second mode 1222 may be controlled by the switching unit 121. Specifically, the switching unit 121 may be controlled to be switched by the rule-based switching method. More specifically, when the criteria is satisfied based on of a predetermined rule, the switching unit 121 may change the mode 122 of the autonomous mobile robot 100 from the first mode 1221 to the second mode 1222, to enable the autonomous mobile robot 100 to exit the local minimum. When it becomes out of the criteria, the switching unit 121 may determine that the autonomous mobile robot 100 has exited the local minimum, switch the mode 122 of the autonomous mobile robot 100 from the second mode 1222 to the first mode 1221, and continue driving to the target point.

As such, the switching unit 121 may switch between the first mode 1221 and the second mode 1222 of the autonomous mobile robot 100 in the rule-based switching method, and the autonomous mobile robot 100 can drive to the destination while easily avoiding the obstacle without being struck in the local minimum.

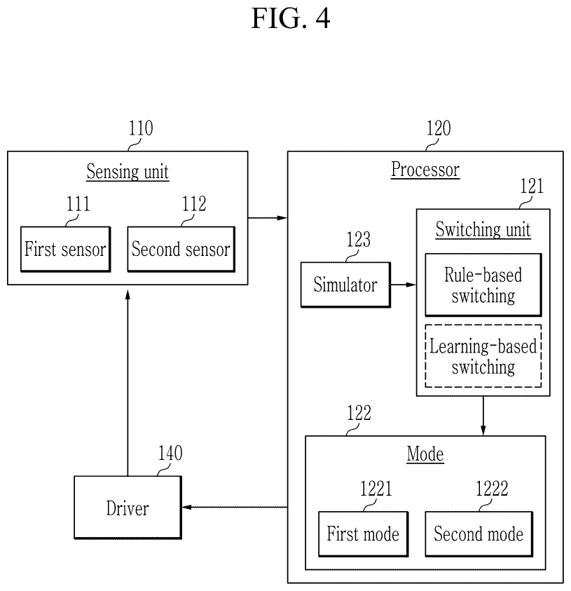

FIG. 4 is a block diagram for the driving procedure of the autonomous mobile robot 100 of according to another embodiment of the present disclosure.

Referring to FIG. 4, the autonomous mobile robot 100 may switch the mode 122 of the autonomous mobile robot 100 by combining the rule-based switching method and a learning-based switching method by the switching unit 121 of the processor 120. Specifically, the autonomous mobile robot 100 may control switching between the first mode 1221 and the second mode 1222 by combining the rule-based switching method and the learning-based switching method.

When the processor 120 switches the mode 122 by only the rule-based switching method, the autonomous mobile robot 100 may encounter a problem of being difficult to perform an efficient path search when a plurality of autonomous mobile robots 100 are disposed as dynamic obstacles to form a complex interaction situation. Specifically, the complex interaction situation may be, for example, the autonomous mobile robot 100 is unnecessarily switched from the first mode 1221 to the second mode 1222 due to mistaken recognition between multiple robots as fixed obstacles. Accordingly, the autonomous mobile robot 100 may encounter a problem of the efficiency of the path searching being deteriorated.

In an embodiment, in switching between the plurality of modes, the processor 120 may utilize the learning-based switching method. The learning-based switching method may overwrite the determined value determined based on rules described above by learning the expert demonstration data, and in a complex interaction environment, may assist the autonomous mobile robot 100 to switch between the plurality of modes more efficiently.

When another autonomous mobile robot other than the autonomous mobile robot 100 is disposed adjacent, the learning-based switching method can prevent the problem of generating a path searching error by recognizing each other as an obstacle in an interaction environment between the plurality of autonomous mobile robots.

As such, as the autonomous mobile robot 100 of the present disclosure is driven while switching between the first mode and the second mode by using the rule-based and/or the learning-based switching method, the autonomous mobile robot 100 may be prevented from being struck in the local minimum, and the problem of mis-recognition of obstacles between multiple robots may be prevented, so that the robot may smoothly reach the target point and the path searching efficiency and the success rate may be improved.

The switching of the learning-based method may efficiently change the mode 122 in an environment in which multiple robots are disposed by combining the rule-based method. Specifically, the switching of the learning-based method may use a neural network model learned based on the expert demonstration data. More specifically, in an environment in which multiple robots are disposed, the switching of the learning-based method may overwrite the result value derived by the rule-based method and preferentially perform switching of the learning-based method.

In an embodiment, the learning-based switching method may switch between the first mode 1221 and the second mode 1222 of the autonomous mobile robot 100 by using a vision transformer (ViT)-based neural network. Specifically, the learning-based switching method may process data obtained from the sensing unit 110 and the state information of the autonomous mobile robot 100 by using a vision transformer model learned based on the expert demonstration data and switch the mode 122 of the autonomous mobile robot 100 more efficiently based on this.

The learning-based switching method may determine the switching of the mode 122 of the autonomous mobile robot 100 based on the learned pattern. Through this, the switching of the mode 122 may be performed more effectively in a complex interaction situation among a plurality of robots. Specifically, the learning-based switching method can solve the problem in which the mode is unnecessarily switched to the second mode 1222 by recognize each other among multiple robots as a fixed obstacle having only limited communication.

The processor 120 may include a simulator 123 that performs simulation on data applied to the learning-based switching method described above. Specifically, the simulator 123 may collect mode switching decision data of experts in various environments (Train Map). The simulator 123 may be applied to the switching unit 121, specifically, the learning-based switching method, and may learn a method for handling an interaction problem occurring in a multiple-robot environment.

As such, the autonomous mobile robot 100 of the present disclosure can perform the switching of the mode 122 by combining the rule-based switching method and the learning-based switching method, and determine each other among multiple robots as a fixed static obstacle, so as to prevent forming of an unnecessary path, thereby improving the path searching efficiency.

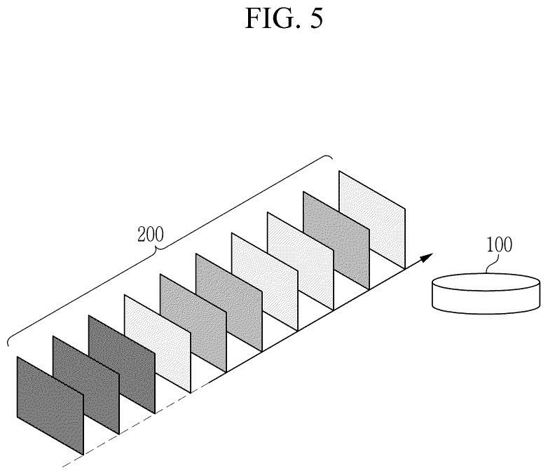

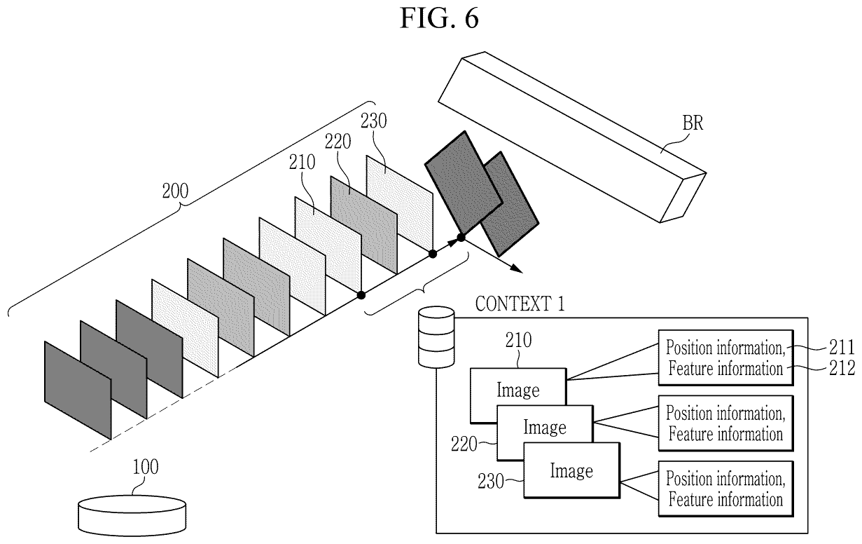

FIG. 5 and FIG. 6 are drawings for explaining an example of securing peripheral data of the autonomous mobile robot 100 according to an embodiment of the present disclosure.

Referring to FIG. 5, in an embodiment, while the autonomous mobile robot 100 is being driven, the processor 120 of the autonomous mobile robot 100 may perform a control so that the sensing unit 110 may obtain a plurality of data while securing peripheral data. The peripheral data may mean information on a point at which the autonomous mobile robot 100 is located, a distance to the target point, or continuously obtained information such as an image of surroundings.

For example, the processor 120 of the autonomous mobile robot 100 may secure peripheral data 200 through the sensing unit 110, and extract a plurality of key-points from the peripheral data. The processor 120 may convert the peripheral data 200 into vector data by using the plurality of key-points. The vector data may be separately stored in the storage unit 130, and the storage unit 130 may be linked with the processor 120 to continuously transmit/receive information on the plurality of vector data.

Referring to FIG. 6, the autonomous mobile robot 100 may secure a plurality of peripheral data 200 in the process of driving while avoiding an obstacle BR. Specifically, the peripheral data 200 may include a plurality of data 210, 220, and 230.

In an embodiment, the sensing unit 110 of the autonomous mobile robot 100 may sense feature information 212 such as position information 211 and the state information of the robot. Specifically, the autonomous mobile robot 100 may obtain the position information 211 on the plurality of data 210, 220, and 230 while driving.

The position information 211 may be information obtained through an omni-directional distance sensor, meaning information such as a distance between the destination or the obstacle and the autonomous mobile robot. The autonomous mobile robot 100 may convert the position information 211 on the plurality of data 210, 220, and 230 into vector data and store it.

In an embodiment, the autonomous mobile robot 100 may extract each feature information 212 from the plurality of data 210, 220, and 230. The feature information 212 may mean information such as information on the current position of the autonomous mobile robot 100 using a sensor for collecting the state information of the robot. Specifically, the autonomous mobile robot 100 may store context data further including feature information extracted from the plurality of data 210, 220, and 230.

The feature information 212 may include information on the points through which the autonomous mobile robot 100 has previously pass. Specifically, the feature information 212 may be the state information of the autonomous mobile robot 100 when the autonomous mobile robot 100 is disposed around the local minimum or disposed at the local minimum in the first mode.

In an embodiment, when the autonomous mobile robot 100 is switched from the first mode 1221 to the second mode 1222 by the obstacle BR, information at a hit point HP and a leave point LP may be stored in the storage unit 130. The hit point HP and the leave point LP may be major points recorded when a mode of the autonomous mobile robot 100 is switched.

The hit point HP may be information when the autonomous mobile robot 100 is in a state of being disposed adjacent to the local minimum or disposed at the local minimum in the first mode 1221 and being unable to move forward any more to reach the destination. Specifically, the hit point HP may be updated a time point at which switched from the first mode 1221 to the second mode 1222.

In an embodiment, the hit point HP may be updated when the distance to the target point is smaller than a distance at the stored hit point HP. Specifically, when disposed around the local minimum, the autonomous mobile robot 100 may continuously update the hit point HP. Specifically, the hit point HP may be updated when the distance to the target point is smaller than a distance at a previously stored hit point HP.

This may prevent unnecessary path repetition by updating the hit point HP only when the autonomous mobile robot 100 became further closer to the target point. Through this, the autonomous mobile robot 100 may be controlled to not move along a path going away from the target point.

In more detail, the previously recorded hit point HP may use a function of checking whether the autonomous mobile robot 100 has fallen into a loop state while performing the second mode 1222, as an input value. More specifically, whether the autonomous mobile robot 100 visits again the hit point HP that has been passed through previously may be checked from the state information of the autonomous mobile robot 100, and when the hit point HP is visited again, it may be determined as the loop state.

In this case, a direction indicator I_{dir} of the autonomous mobile robot 100 may perform the second mode 1222 to have a symbol value opposite to a direction indicator constant of the previous second mode 1222. Through this, an inefficient situation in which the autonomous mobile robot searches again the previously visited path may be prevented.

The leave point LP may be set when the autonomous mobile robot 100 is switched from the second mode 1222 to the first mode 1221 again. Specifically, the leave point LP may mean a switching point to return back to the first mode 1221 when the autonomous mobile robot 100 became out of the local minimum while moving along a wall.

In an embodiment, the leave point LP may be set to a new leave point LP whenever the autonomous mobile robot 100 is switched from the second mode 1222 to the first mode 1221. The autonomous mobile robot 100 may store a plurality of leave points LP recorded whenever the mode is switched, which may be utilized at a subsequent mode switching, and thereby the autonomous mobile robot 100 may be prevented from repeating the same path.

In more detail, when the distance to the target point has decreased from the hit point HP, the autonomous mobile robot 100 may terminate the second mode 1222 and be switched to the first mode 1221. In another embodiment, when located again on a straight line path (M-Line) toward the target point, the autonomous mobile robot 100 may be switched from the second mode 1222 to the first mode 1221.

As such, efficient path search may be performed so that an unnecessary switching to the second mode 1222 may be prevented and the autonomous mobile robot 100 may reach the target point relatively rapidly.

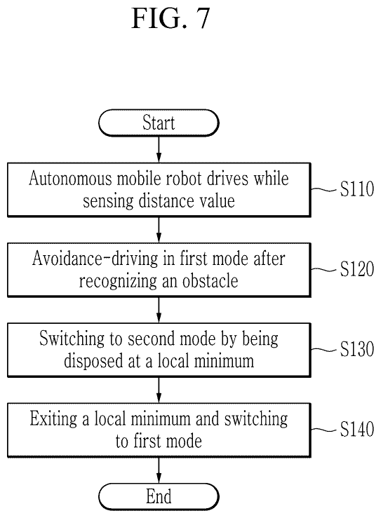

FIG. 7 to FIG. 9 are flowcharts for a driving method of the autonomous mobile robot of according to an embodiment of the present disclosure, and FIG. 10 is a schematic view for the driving procedure of the autonomous mobile robot of according to an embodiment of the present disclosure. In describing FIG. 7 to FIG. 10, for the detailed description of configurations for driving the autonomous mobile robot and operations thereof, the content of FIG. 1 to FIG. 6 described above may be referred to, to the extent that do not contradict each other.

Referring to FIG. 7, the driving method of the autonomous mobile robot of the present disclosure may include a step S110 in which the autonomous mobile robot 100 is driven while sensing the distance value, a step S120 of recognizing an obstacle and avoidance-drive in the first mode, a step S130 of being disposed at the local minimum and switching to the second mode, and a step S140 of exiting the local minimum and switching to the first mode. Specifically, when the obstacle is recognized while driving, the autonomous mobile robot 100 may switch between the first mode and the second mode and the autonomous mobile robot may exit the local minimum while avoiding the obstacle while.

In the step S110 in which the autonomous mobile robot is driven while sensing the distance value, the autonomous mobile robot 100 may be driven while sensing the distance value through the sensing unit. Specifically, the autonomous mobile robot 100 may be driven while measuring the distance to the target point or the obstacle by using a distance sensor such as a lidar sensor within the sensing unit. The distance sensor may perform, for example, 360° omni-directional distance measurement, and drive while detecting the target point and the surrounding obstacles.

When the obstacle is recognized during the driving of the autonomous mobile robot 100, the step S120 of recognizing an obstacle and avoidance-drive in the first mode may avoid the obstacle by the first mode. The first mode may be, for example, an artificial potential field. The artificial potential field may determine the moving direction by using relative position vectors from the autonomous mobile robot 100 to the obstacles and the target point by using the sensed distance value.

The step S130 of switching to the second mode by being disposed at the local minimum may be a step of switching from the first mode to the second mode when the autonomous mobile robot 100 is disposed as the local minimum by an obstacle or disposed adjacent to the local minimum while driving. The second mode may be, for example, a wall-following mode. The wall surface estimation mode may control the autonomous mobile robot 100 to move along a wall of the obstacle.

In more detail, when the autonomous mobile robot 100 became close to the local minimum by using the distance sensor, the autonomous mobile robot 100 may move along the obstacle by being automatically switched from the first mode to the second mode. Specifically, the autonomous mobile robot 100 may periodically detect relative position vectors of the surrounding obstacles and the target point in real time by using an omni-directional distance sensor. By the subsequent moving direction of the autonomous mobile robot 100 may be determined by calculating a magnitude of the force of the autonomous mobile robot 100 calculated from the relative position vector value by the artificial potential field.

When disposed as the local minimum by a dynamic obstacle such as a nonconvex obstacle or another autonomous mobile robot or disposed around the local minimum, the autonomous mobile robot 100 may switch the mode from the first mode to the first mode and move along an edge of the obstacle or the autonomous mobile robot 100 to exit the local minimum. As such, the autonomous mobile robot 100 may switch the mode by the rule that the autonomous mobile robot 100 is disposed at the local minimum or disposed adjacent to the local minimum.

The step S140 of exiting from the local minimum and switching to the first mode may be a step of moving toward the target point by re-switching the second mode that is a wall-following mode to the first mode that is an artificial potential field when the autonomous mobile robot 100 has exited the local minimum. Specifically, when a rotation angle θᵣₒₜ of the autonomous mobile robot 100 does not satisfy 0°, the autonomous mobile robot 100 may maintain the second mode. When the rotation angle θᵣₒₜ satisfies 0°, the second mode may be switched to the first mode so that the autonomous mobile robot 100 may move back to the target point.

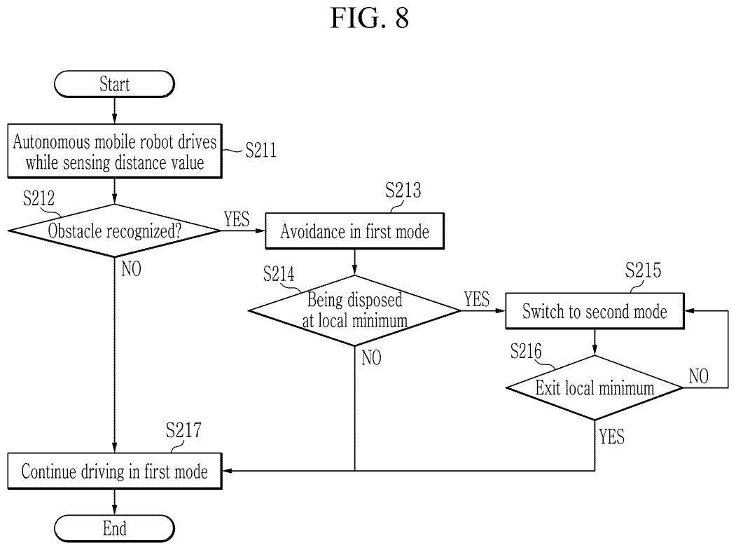

Referring to FIG. 8 and FIG. 10, the autonomous mobile robot 100 may drive according to the rule-based switching method. Specifically, at step S211 in which the autonomous mobile robot 100 is driven while sensing the distance value, the driving method of the autonomous mobile robot 100 may perform a control to drive while calculate the distance value between the obstacle BR and the target point TP by an omni-directional distance sensor such as a lidar sensor.

Thereafter, when the obstacle BR is recognized at step S212 of recognizing the obstacle BR by the autonomous mobile robot 100, a step S213 of avoiding it in the first mode may be performed. When the obstacle BR is not recognized at the step S212 of recognizing the obstacle BR by the autonomous mobile robot 100, the autonomous mobile robot 100 may normally drive through a step S217 of continuously driving in the first mode toward the target point TP.

The autonomous mobile robot 100 having performed the step S213 of avoiding the obstacle BR in the first mode may perform a step S214 of determining whether the autonomous mobile robot 100 is disposed at the local minimum. When it is determined that the autonomous mobile robot 100 is not disposed at the local minimum at the step S214 of determining whether the autonomous mobile robot 100 is disposed at the local minimum, it may normally drive through the step S217 of continuously driving in the first mode.

When the autonomous mobile robot 100 is disposed at the local minimum at the step S214 of determining whether the autonomous mobile robot 100 is disposed at the local minimum, the autonomous mobile robot 100 may perform a step S215 of switching from the first mode to the second mode. The autonomous mobile robot 100 having performed the step S215 of switching to the second mode may move along the edge of the obstacle BR or another autonomous mobile robot, in order to exit the local minimum.

Thereafter, when the autonomous mobile robot 100 has exited the local minimum through a step S216 of determining whether the autonomous mobile robot 100 has exited the local minimum, it may normally drive through the step S217 of continuously driving in the first mode.

When the autonomous mobile robot 100 has not exited the local minimum through the step S216 of determining whether the autonomous mobile robot 100 has exited the local minimum, the second mode may be performed until the autonomous mobile robot 100 exits the local minimum.

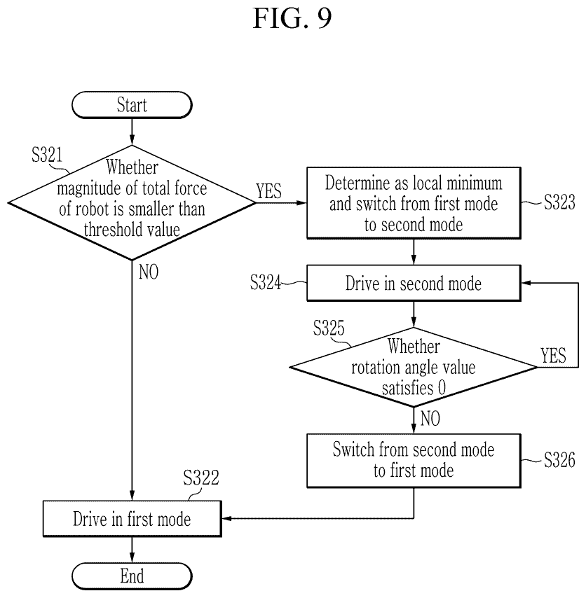

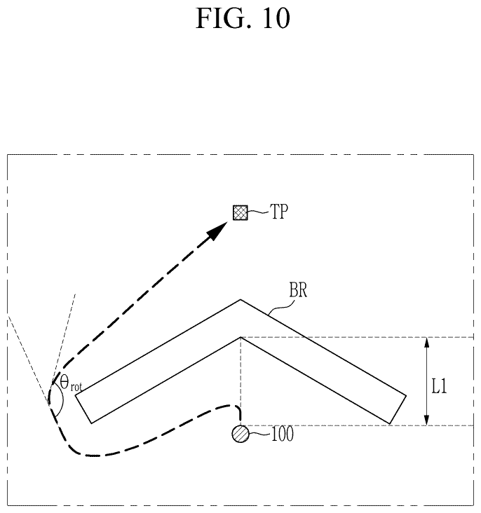

Referring to FIG. 9 and FIG. 10, the driving method of the autonomous mobile robot 100 of the present disclosure may drive while switching between the first mode and the second mode of the autonomous mobile robot 100, depending on whether the magnitude of the force of the autonomous mobile robot 100 satisfies a predetermined rule. Specifically, the driving method of the autonomous mobile robot 100 may include a step S321 of determining whether the magnitude of the total force of the autonomous mobile robot 100 is smaller than a threshold value.

In an embodiment, the autonomous mobile robot 100 switched to the first mode may be switched to the second mode when Equation 1 below is satisfied.

$$\vert {F}_{t o t} \vert \leq {f}_{thr} \qquad < Equation 1 >$$

Here, Fₜₒₜ of the Equation 1 means a weighted sum of an attractive force for attracting the autonomous mobile robot 100 from the target point and a repulsive force for moving the autonomous mobile robot 100 away from the obstacle to avoid collision, and fₜₕᵣ means a predetermined threshold value.

The Equation 1 may be a switching indicator from the first mode to the second mode. Specifically, the Equation 1 may be whether a weighted sum of the attractive force and the repulsive force satisfies being smaller than or equal to a predetermined threshold value in an artificial potential field.

In an embodiment, a threshold value fₜₕᵣ is half a longest distance value L1 among the distance values measured from the sensing unit. For example, a lidar sensor, which is a distance sensor in the sensing unit may rotate 360° and omni directionally measure the distances. A half of a longest distance value having a longest value among the measured distance values may be defined as the threshold value.

When the sum of total forces of the autonomous mobile robot 100 is smaller than or equal to the previously defined threshold value, it may determine that the autonomous mobile robot 100 is disposed around the local minimum. When the autonomous mobile robot 100 satisfies the Equation 1, in order to exit the local minimum, it may be controlled to switch the autonomous mobile robot from the first mode to the second mode.

In an embodiment, the autonomous mobile robot 100 switched to the second mode may be switched to the first mode when Equation 2 below is satisfied.

$$\vert {F}_{t o t} \vert > {f}_{thr} \qquad < Equation 2 >$$

Here, Fₜₒₜ of the Equation 2 means a weighted sum of an attractive force for attracting the autonomous mobile robot 100 from the target point and a repulsive force for moving the autonomous mobile robot 100 away from the obstacle to avoid collision, and fₜₕᵣ means a predetermined threshold value.

The Equation 2 may be a switching indicator from the second mode to the second mode. Specifically, the Equation 2 may be whether a weighted sum of the attractive force and the repulsive force exceeds the predetermined threshold value in an artificial potential field. When the Equation 2 is satisfied, it is determined to be a state in which the autonomous mobile robot 100 is capable of normal driving by exiting the local minimum, and a control may be performed to switch from the second mode to the first mode.

As such, when the magnitude of the total force of the autonomous mobile robot 100 is greater than the threshold value, the autonomous mobile robot 100 may perform a step S322 of driving in the first mode. In contrast thereto, when the magnitude of the total force of the autonomous mobile robot 100 is smaller than or equal to the threshold value, a step S323 of determining it as the local minimum and switching from the first mode to the second mode and a step S324 of driving in the second mode may be performed.

Thereafter, the driving method of the autonomous mobile robot 100 may perform a step S325 of determining whether the rotation angle value satisfies 0°. In an embodiment, when the magnitude of a total force Fₜₒₜ calculated by the autonomous mobile robot 100 is less than or equal to the threshold value fₜₕᵣ, an absolute value of the rotation angle θᵣₒₜ may increase. Specifically, when the autonomous mobile robot 100 is disposed around the local minimum, the autonomous mobile robot 100 may rotate while controlling the rotation angle θᵣₒₜ so as not to satisfy 0° based on the driving direction.

In an embodiment, when the magnitude of the total force Fₜₒₜ calculated by the autonomous mobile robot 100 exceeds the threshold value fₜₕᵣ, the rotation angle θᵣₒₜ may gradually decrease. Specifically, when the autonomous mobile robot 100 exits the local minimum, the autonomous mobile robot 100 may drive in a normal driving direction toward the target point TP.

In an embodiment, the first mode may be performed by resetting the rotation angle θᵣₒₜ of the autonomous mobile robot 100 to 0°. Specifically, in the second mode, in the autonomous mobile robot 100 switched to the first mode, the rotation angle θᵣₒₜ may satisfy 0° based on the driving direction. When the rotation angle θᵣₒₜ of the autonomous mobile robot 100 is switched from a value greater than 0° to 0°, it may be determined that the autonomous mobile robot 100 has exited the local minimum to be switched to the first mode and perform the normal driving.

In an embodiment, the autonomous mobile robot 100 may measure a direction in which a point of a closest distance to the target point TP among data measured by a sensor unit is located, determine the direction indicator I_{dir} of the autonomous mobile robot 100 based on this, and thereby perform switching between the first mode and the second mode. Specifically, the processor may measure a direction in which a point of a closest distance among the points measured by the distance sensor by using an algorithm is located, and determine the direction indicator constant based on this.

Based on the determined direction indicator I_{dir}, the autonomous mobile robot 100 may update the rotation angle θᵣₒₜ. Specifically, the autonomous mobile robot 100 may avoid the obstacle while rotating according to the rotation angle θᵣₒₜ according to the direction indicator I_{dir}. For example, the autonomous mobile robot 100 may rotate counterclockwise when the direction indicator I_{dir} satisfies 1, and may avoid the obstacle while rotating clockwise when the direction indicator I_{dir} satisfies −1.

As such, at the step S325 of determining whether the rotation angle value of the autonomous mobile robot 100 satisfies 0°, when the rotation angle of the autonomous mobile robot 100 satisfies 0°, the autonomous mobile robot 100 may perform the step S322 of driving in the first mode through a step S326 of switching from the second mode to the first mode. In contrast thereto, when the rotation angle of the autonomous mobile robot 100 does not satisfy 0°, it may be determined that the autonomous mobile robot 100 does not exit the obstacle BR or the local minimum and the step S324 of driving in the second mode may be continuously performed.

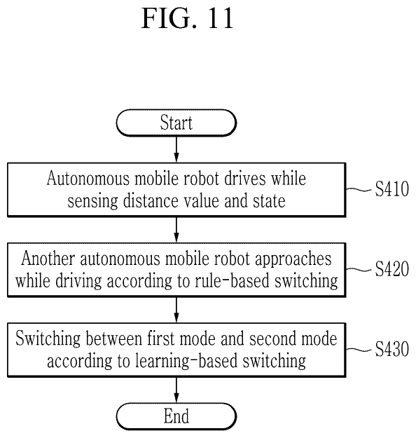

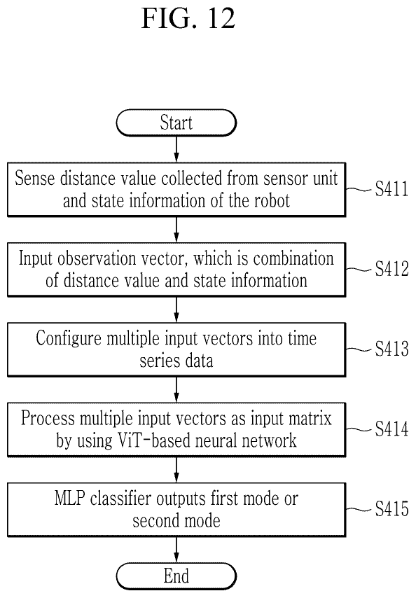

FIG. 11 and FIG. 12 are flowcharts for a driving method of the autonomous mobile robot 100 according to another embodiment of the present disclosure, and FIG. 13 is a schematic view for the driving procedure of the autonomous mobile robot of according to another embodiment of the present disclosure.

Referring to FIG. 11 and FIG. 13, in an embodiment, when another autonomous mobile robot 100′ other than the autonomous mobile robot 100 is disposed adjacent, the driving method of the autonomous mobile robot 100 may drive to the target points TP and TP′ while switching the mode of the autonomous mobile robot by combining the rule-based switching method and the learning-based switching method, in order to prevent recognizing the autonomous mobile robot 100 as the fixed obstacle BR.

The driving method of the autonomous mobile robot 100 may include a step S410 in which the autonomous mobile robot 100 is driven while sensing the distance value and state, a step S420 in which another autonomous mobile robot 100′ approaches while driving according to rule-based switching, and a step S430 of switching between the first mode and the second mode by the learning-based switching. Specifically, the autonomous mobile robot 100 may preferentially apply the learning-based switching method based on the expert demonstration data than the rule-based switching method, and thereby solve the problem of recognizing each other among the autonomous mobile robots 100 and 100′ as a static obstacle, so that the path searching efficiency and the success rate of the autonomous mobile robot may be improved.

The step S410 in which the autonomous mobile robot 100 is driven while sensing the distance value and state may be a step of measuring the distance between the autonomous mobile robot 100 and the target point or obstacle through a plurality of sensors, and driving while measuring the state information such as the past and present position information of the autonomous mobile robot 100. For example, the autonomous mobile robot 100 may continuously update the distance value and the state information by using the first sensor that is a distance sensor and the second sensor that is the state measurement sensor, and drive in the first mode that is an artificial potential field.

The autonomous mobile robot 100 may drive in the first mode, and when the obstacle BR or the local minimum is recognized during driving, by the rule-based switching method described above, the autonomous mobile robot 100 may drive while exiting the obstacle BR or the local minimum.

The step S420 in which another autonomous mobile robot 100′ approaches while driving according to rule-based switching may be a step of recognizing another autonomous mobile robot 100′ in a region adjacent to the autonomous mobile robot 100 driving by the rule-based switching method. There may be a problem that, even though another autonomous mobile robot 100′ is a dynamic obstacle, the rule-based switching method recognizes it as a static obstacle and unnecessarily switches to the second mode.

In more detail, when another autonomous mobile robot 100′ approaches, the rule-based switching method may recognize the autonomous mobile robot 100′ as a static obstacle to excessively perform switching to the second mode, thereby deteriorating the efficiency of the path. As such, the rule-based switching method may have a problem that the efficient path setting may not be performed in a complex interaction situation among multiple robots.

The step S430 of switching between the first mode and the second mode by the learning-based switching may be a step of switching the mode of the autonomous mobile robot 100 by combining the learning-based switching method, in order to solve the problem of the rule-based switching method described above. Specifically, the learning-based switching method may overwrite the decision of the rule-based switching method by learning the expert demonstration data, and perform the mode switching that is more suitable for driving among multiple robots.

In more detail, the learning-based switching method may process information obtained from the sensing unit of the autonomous mobile robot by using the vision transformer model learned based on the expert demonstration data, and may perform a control so that the autonomous mobile robot 100 may appropriately switch between the first mode that is an artificial potential field and the second mode that is a wall-following mode.

In more detail, the learning-based switching method may determine switching of the mode based on the learned pattern. Specifically, the learned pattern may be information collected and learned through a simulation environment (Train Map). The collected and learned information can collect mode switching decision data of experts with respect to various environments performed by a simulation unit, and can learn a method for handling an interaction problem occurring in a multiple-robot environment.

As such, the learning-based switching method assist the autonomous mobile robot 100 to switch more efficiently between the first mode and the second mode in a complex interaction environment.

Referring to FIG. 12 and FIG. 13, in an embodiment, the learning-based switching method may include a step S411 of sensing the state information of the robot and the distance value collected from the sensing unit, a step S412 of inputting an observation vector that is a combination of the distance value and the state information, a step S413 of configuring a plurality of input vectors as time series data, a step S414 of processing the plurality of input vectors as an input matrix by using the ViT-based neural network, and a step S415 in which an MLP classifier outputs the first mode or the second mode. The learning-based switching method may learn the path pattern by utilizing information on the distance value collected from the distance sensor and the state information collected from the state measurement sensor.

The step S412 of inputting the observation vector that is a combination of the distance value and the state information may be a step in which the observation vector that is a combination of the distance value collected from the distance sensor and the state measurement sensor and the state information of the autonomous mobile robot is used as an input. Specifically, the distance sensor may obtain, for example, information on a plurality of distance values through an omni-directional lidar sensor, and the state information sensor may obtain the relative position between the target point and the autonomous mobile robot, information on the previous hit point and leave point, various pieces of information such as the past and present rotation angles of the autonomous mobile robot as state information of 15 dimensions or more.

The step S413 of configuring the plurality of input vectors into time series data may be a step of configuring the plurality of input vectors in a matrix form. Specifically, a vision transformer encoder may receive the plurality of input vectors and extract features for mode switching of the autonomous mobile robot. Through this process a mode according to the situation of the autonomous mobile robot, for example, the first mode or the second mode, may be determined.

The step S414 of processing the plurality of input vectors as the input matrix by using the ViT-based neural network may process an input matrix with respect to the input observation vector. The vision transformer (ViT) encoder may process the input observation vector into the input matrix through patch embedding. During this process, the autonomous mobile robot may identify the surrounding environment and operation of other autonomous mobile robots, and may learn the decision pattern of the expert.

The structure of the vision transformer encoder may include dividing the input matrix data into small patch units, converting each patch into an embedding vector, and then analyzing the co-relationship between the patches through a multi-head attention.

In more detail, the patch embedding may be a step of converting the input matrix data into a vector of, for example, 1×(M+17) size (M may be constant). The above patch embedding can be input to a vision transformer encoder by dividing a vector of the above-mentioned size into patches of a size that divides the input vector into small parts.

In more detail, the multi head attention may mean a mechanism for learning the interaction between the patches of the transformer encoder. Respective heads may analyze different respective characteristics of the input data, to learn the various co-relationships. For example, the number of the head may use eight attention heads. At this time, the input data may be processed by using four transformer blocks each being configured as an attention layer and a feedforward layer. The transformer block may be a hidden unit dimension configured to process information extracted from each patch by using a hidden size of 512 dimensions.

The step S415 in which the multi-layer perceptron (MLP) classifier outputs output the first mode or the second mode may be a step in which the MLP classifier outputs the first mode or the second mode based on a feature vector extracted by the vision transformer encoder, so that the autonomous mobile robot can select an appropriate operation for the situation.

The feature vector of 512 dimensions output from the vision transformer may be input into the MLP classifier. Specifically, the MLP classifier may be configured as three pieces of 512 dimensional fully connected layers (FC layer), and after each FC layer, the ReLU activation function may be applied. In addition, a second FC layer may have an output dimensionality of 1, and for the final output, may output the first mode or the second mode according to the binary classification result by using the Sigmoid function.

As such, by combining the learning-based switching method to the rule-based switching method and utilizing it, according to a simple rule, in order to supplement the decision of the rule-based switching method for switching the mode, a decision capable of improving the efficiency of the path searching in a complex situation by learning the decision pattern of the expert may be performed.

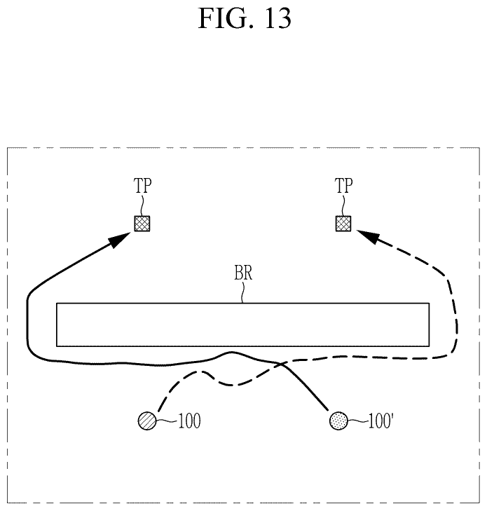

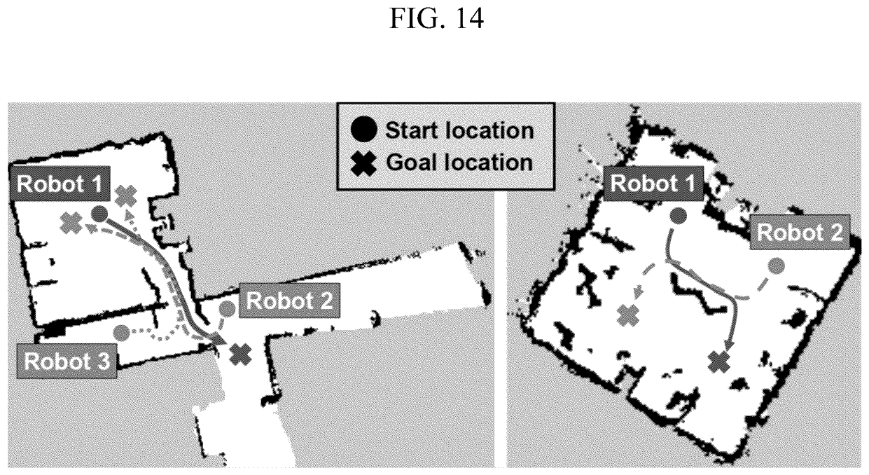

FIG. 14 shows an actual implementation environment of the autonomous mobile robot of the present disclosure.

Referring to FIG. 14, a result drawing according to an actual implementation environment of the autonomous mobile robot is shown. A driving circumstances of the autonomous mobile robot in an office room having a nonconvex obstacle is shown in the left, and a driving circumstance of the autonomous mobile robot in a destination that is symmetrically disposed on a side opposite to a wall is shown in the right. Referring to FIG. 14, when the autonomous mobile robot of the present disclosure is utilized, it may be confirmed that a path can be minimized and an efficient path may be successful searched in an environment in which a nonconvex obstacle is disposed or an environment in which multiple robots are disposed. Specifically, the experiment was performed in a complex office environment by using a TurtleBot4 robot.

In the experiment environment shown in the left side of FIG. 14, the autonomous mobile robot utilizing an algorithm combining the artificial potential field and the rule-based switching method and an algorithm combining the artificial potential field and the learning-based switching method was found to exit the local minimum and efficiently reach the target point even in a situation having many nonconvex obstacles.

In the experiment environment shown in the right side of FIG. 14, the autonomous mobile robot utilizing an algorithm combining the artificial potential field and the rule-based switching method and an algorithm combining the artificial potential field and the learning-based switching method successfully solved the problem when the robots located on both sides of the symmetrical wall were in a deadlock.

In contrast thereto, the conventional artificial potential field method was found to be fall into the deadlock in the environment of FIG. 14 shown in the left and right.

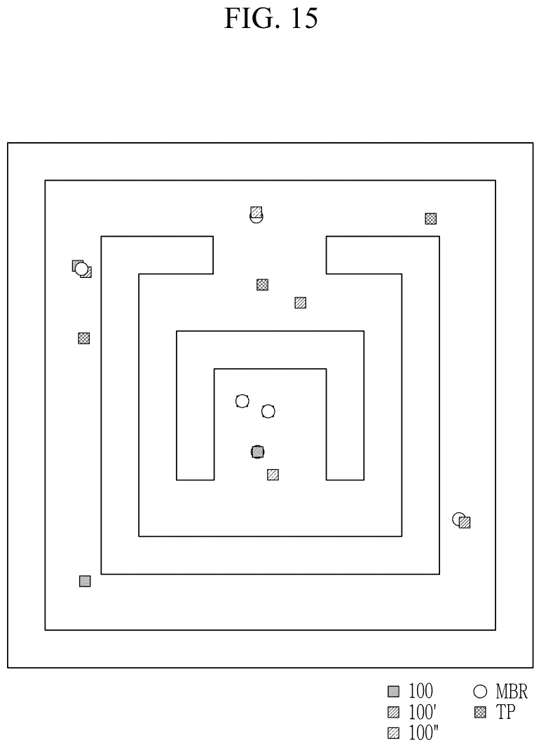

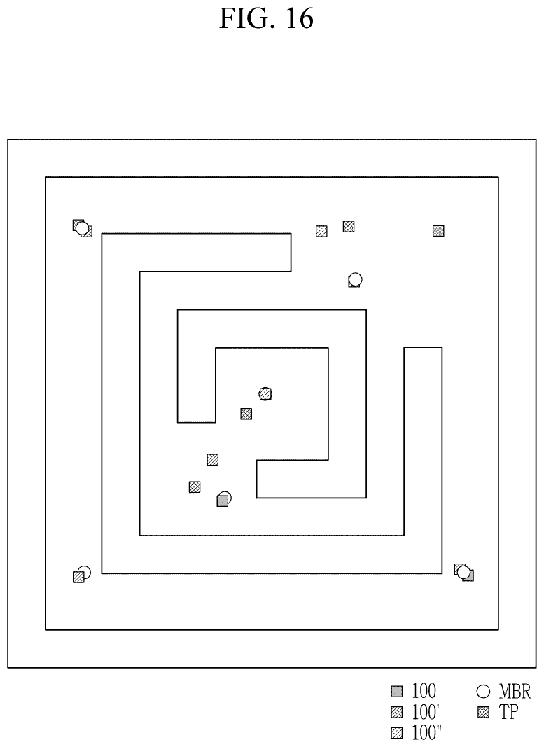

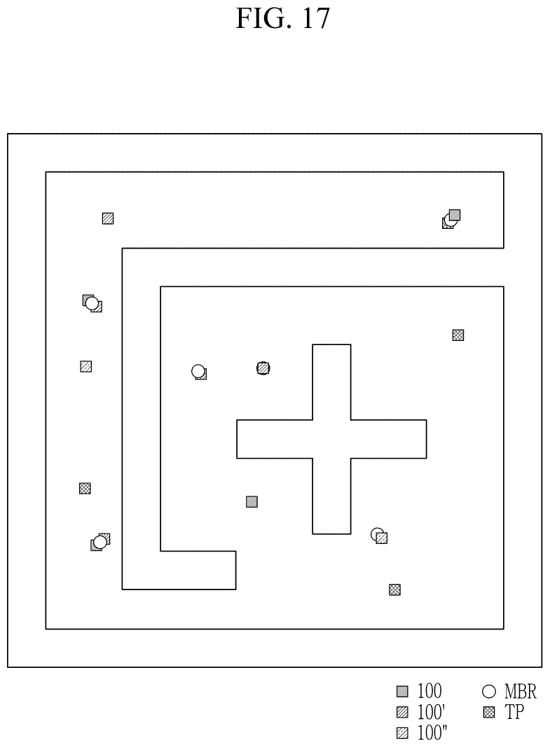

FIG. 15 to FIG. 18 represent a simulation environment for collecting data that may be utilized for the learning-based rule switching of the autonomous mobile robot of the present disclosure.

FIG. 15 to FIG. 18 represent four environments (Train Maps) for collecting learning data configuring the learning-based rule switching of the autonomous mobile robot of the present disclosure. Specifically, FIG. 15 to FIG. 18 illustrate data showing that, in four environments, the autonomous mobile robots 100, 100′, and 100″ drive toward the target point TP while avoiding each other and avoiding a dynamic obstacle MBR and a static the obstacle BR. At this time, for the autonomous mobile robots 100, 100′, and 100″, an expert may control switching between the first mode or the second mode, the dynamic obstacle MBR may be an obstacle moving together with the robot, and an initial position of the autonomous mobile robots 100, 100′, and 100″ and the target point TP may be randomly generated.

The neural network configuring the learning-based rule switching may learn switching between the first mode and the second mode by using a Binary Cross-Entropy Loss (BCELoss) function. Specifically, in the learning process, the learning may be performed for 50 epochs by using the Adam optimizer. At this time, the learning rate may be 0.0003.

As such, by utilizing the pattern learning described above, a pattern that may be utilized to the learning-based rule switching may be learned, and by combining the rule-based switching, the path searching efficiency of the autonomous mobile robot may be further improved.

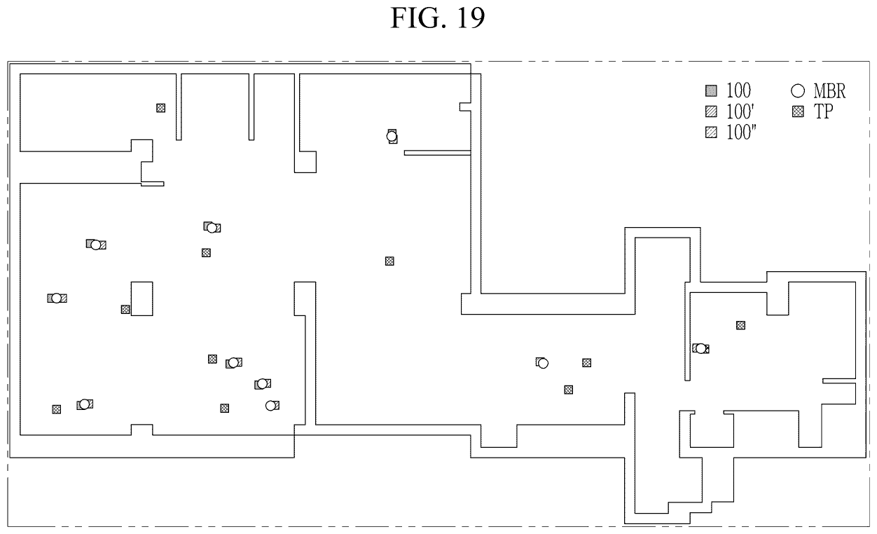

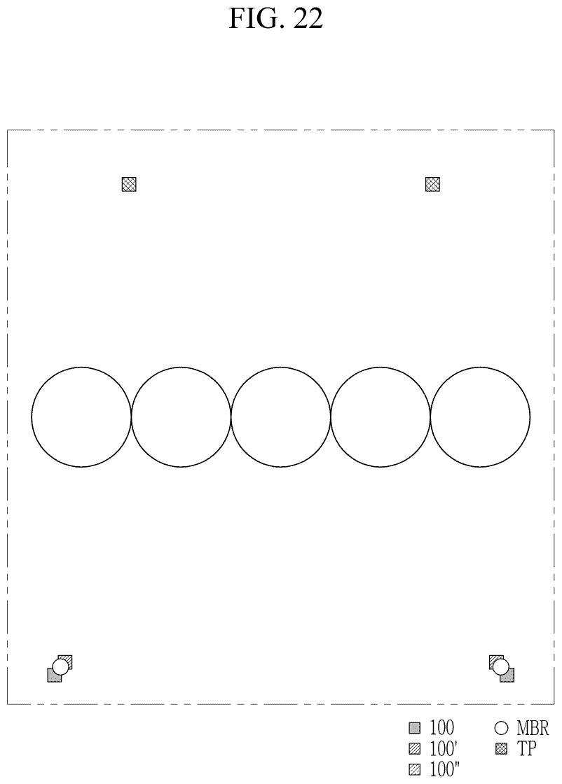

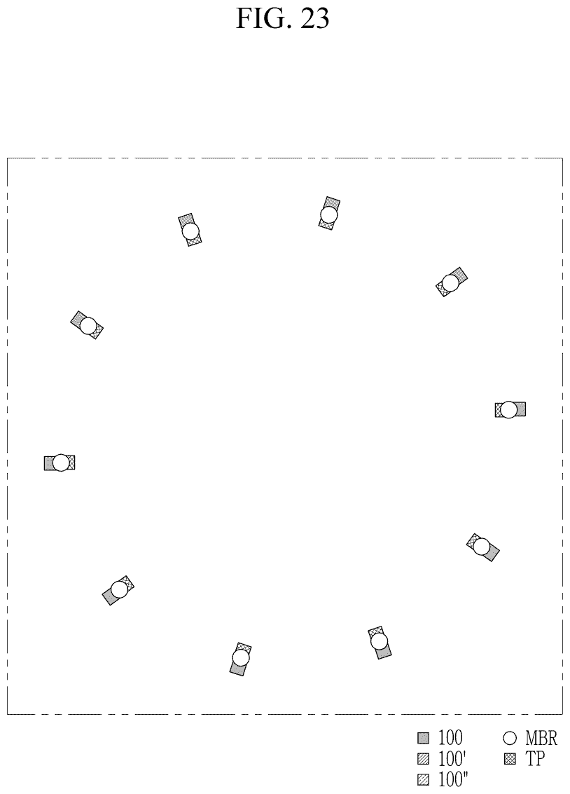

FIG. 19 to FIG. 23 represent an autonomous mobile robot of the present disclosure and a simulation experiment environment of the autonomous mobile robot of a Comparative Example.

FIG. 19 to FIG. 23 will be described below with reference to the Nakwon environment, the Sogang environment, the Flat environment, the Cylind environment, and the Swap environment, respectively, as the simulation experiment environment of the autonomous mobile robot. Specifically, in order to verify the performance and effect of the driving based on the learning-based switching method and a rule switching method proposed in the present disclosure, the experiment was performed in the simulation environments shown in FIG. 19 to FIG. 23.

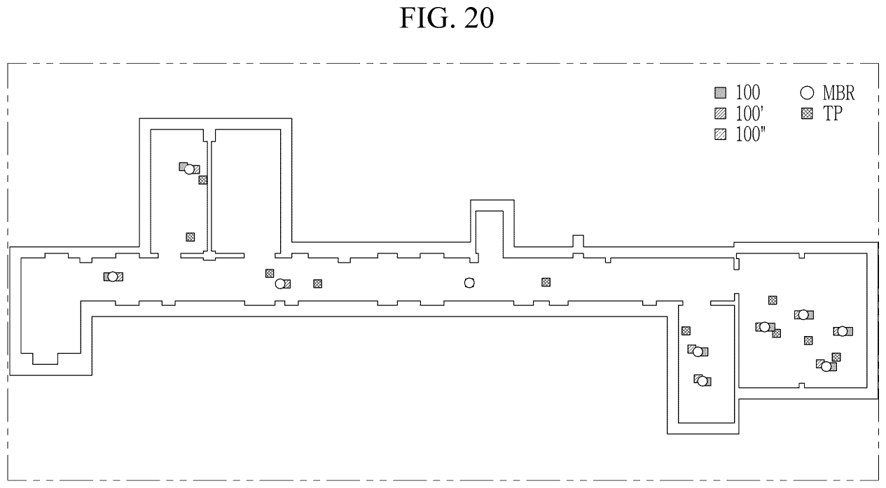

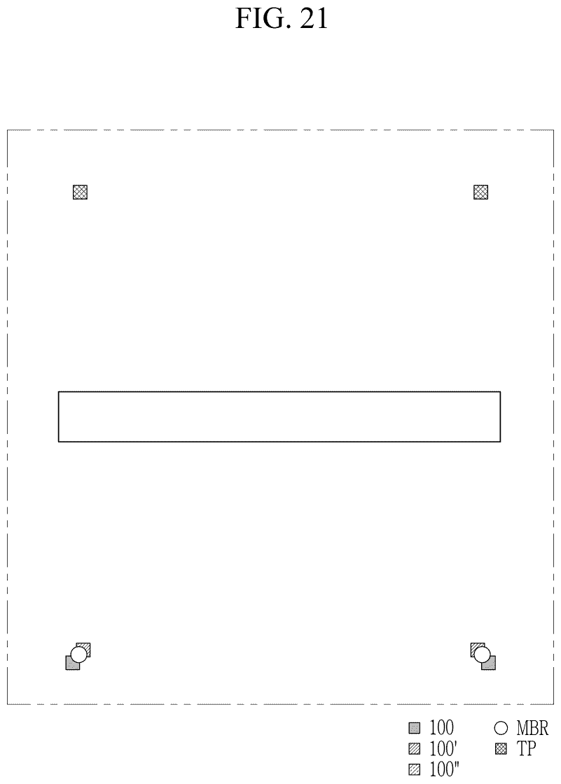

In order to experiment the applicability in the actual environment based on an actual building plan view, two real world layouts as shown in FIG. 19 and FIG. 20 were performed. In addition, the symmetric layouts of FIG. 21 to FIG. 23 were used in order to simulate the problem of mis-recognizing other autonomous mobile robots as static obstacles and test the solving ability of each algorithm, in the symmetrical situation. In FIG. 19 and FIG. 20, the experiment was performed by generating 20 experiment instances. In FIG. 21 to FIG. 23, the experiment was performed by generating 300 experiment instances.

The following Table 1 and Table 2 represents a maximum reaching timestep (Makespan) among multiple robots in FIG. 19 and FIG. 20 and the mean timestep measurement value. Here, the parentheses indicate the standard deviation.

The following Table 3 and Table 4 represents a maximum reaching timestep among multiple robots in FIG. 21 to FIG. 23 and the mean timestep measurement value.

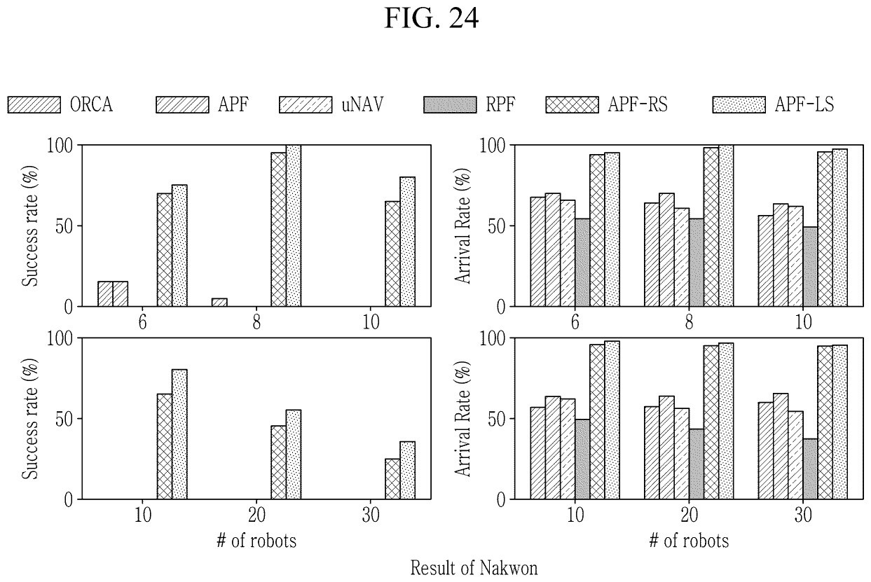

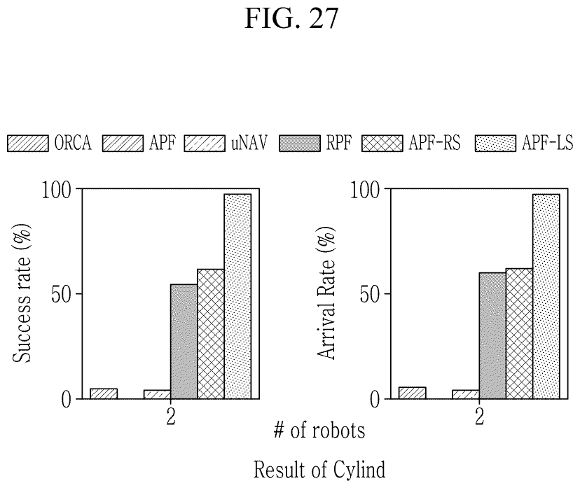

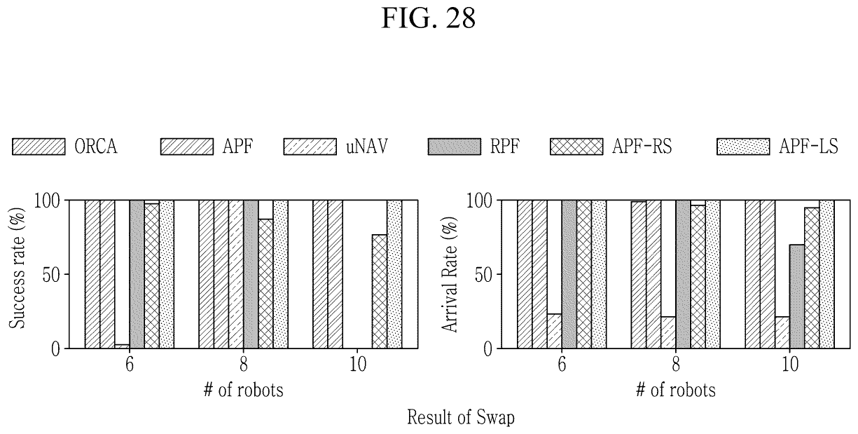

FIG. 24 to FIG. 28 are result graphs according to the simulation experiment environment of FIG. 19 to FIG. 23.

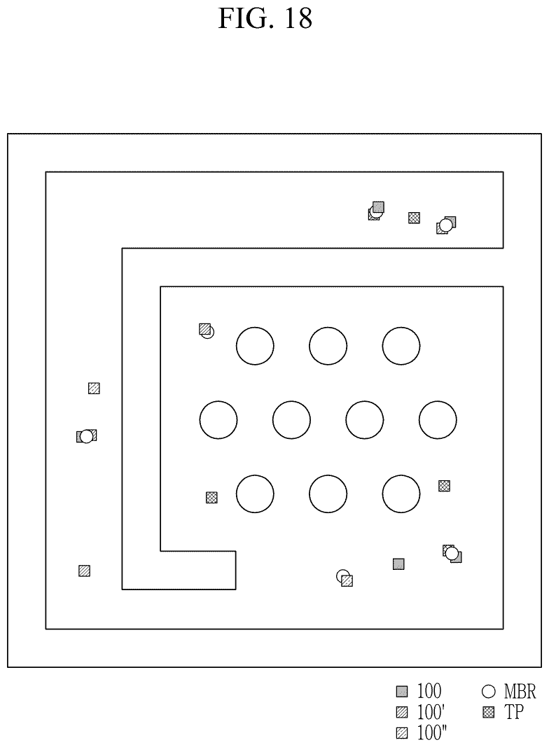

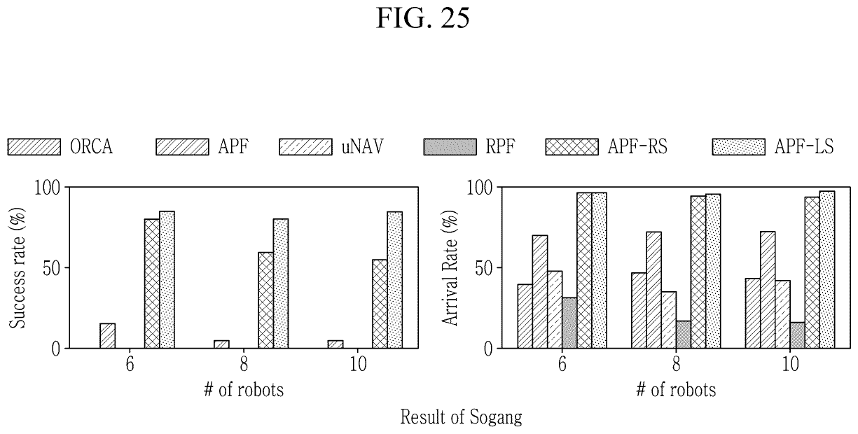

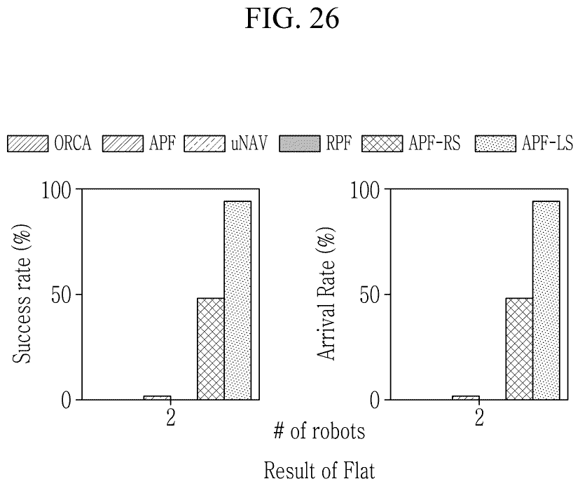

FIG. 24 and FIG. 25 represent the success rate and the arrival rate between multiple robots of FIG. 18 and FIG. 20. FIG. 26 to FIG. 28 represent the success rate and the arrival rate between multiple robots in FIG. 21 to FIG. 23.

At this time, the success rate, the arrival rate, the maximum reaching timestep (Makespan), and the mean timestep were evaluated by the following method.

Success rate: evaluated as a test case ratio in which all robots reach the target point without collision during the entire test.

Arrival rate: evaluated as a total robot ratio having reached the target point among the entire robots.

Maximum reach timestep: a maximum value of the timestep taken for all robots to have reached the target point, meaning a work completion time.

Mean timestep: an average value of the timestep taken for all robots to have reached the target point, meaning an average work time.

In addition, in the following Table 1, ORCA, APF, μNav, RPF, APF-RS, and APF-LS relates to an algorithm for controlling the autonomous mobile robot, respectively, and the following description may be referred to.

ORCA: ORCA is Optimal Reciprocal Collision Avoidance described in Van den Berg, Jur, Ming Lin, and Dinesh Manocha. “Reciprocal velocity obstacles for real-time multi-agent navigation.” ICRA, 2008, which is one of conventional algorithms.

APF: an algorithm for a typical artificial potential field.

μNav: one of conventional algorithms described in F. Mastrogiovanni, A. Sgorbissa, and R. Zaccaria, “Robust navigation in an unknown environment with minimal sensing and representation,” IEEE T-SMC, Part B (Cybernetics), 2008.

RPF: one of conventional algorithms described in Zhang, Dengyu, et al. “Reinforced Potential Field for Multi-Robot Motion Planning in Cluttered Environments,” IROS, 2023.

APF-RS: an algorithm combining the rule-based switching method of the present disclosure with an artificial potential field.

APF-LS: an algorithm combining the learning-based switching method of the present disclosure with an artificial potential field.

TABLE 1

| | | Makespan | | | | | |
|---|---|---|---|---|---|---|---|
| Environment | #Robot | ORCA | APF | μNAV | RPF | APF-RS | APF-LS |
| Nakwon | 6 | 29.7 | 247.7 | — | — | 1465.5 | 1620.5 |
| | | 155.7 | 70.2 | | | (1551.5) | (1602.5) |
| | 8 | 560.0 | — | — | — | 2668.3 | 2533.4 |
| | | 0.0 | | | | (1198.6) | (1249.8) |
| | 10 | — | — | — | — | 2928.8 | 2990.8 |
| | | | | | | (1311.7) | (1150.4) |
| | 20 | — | — | — | — | 3434.7 | 3487.8 |
| | | | | | | 5072 | 570.1 |
| | 30 | — | — | — | — | 3896.0 | 3737.4 |
| | | | | | | 57.9 | 232.6 |
| Sogang | 6 | — | 609.2 | — | — | 1749.1 | 1822.6 |
| | | | 72.9 | | | 850.8 | 802.4 |
| | 8 | — | 609.9 | — | — | 2058.8 | 2119.7 |
| | | | 0.0 | | | 868.9 | 842.4 |
| | 10 | — | 648.0 | — | — | 2168.5 | 2190.9 |
| | | | 0.0 | | | 672.2 | 678.2 |

TABLE 2

| | | Mean timestep | | | | | |
|---|---|---|---|---|---|---|---|
| Environment | #Robot | ORCA | APF | μNAV | RPF | APF-RS | APF-LS |
| Nakwon | 6 | 164.4 | 1135.4 | 459.6 | 213.3 | 729.7 | 702.2 |
| | | 40.8 | 698.3 | 183.0 | 124.5 | 591.5 | 529.2 |
| | 8 | 169.6 | 1195.4 | 516.3 | 201.1 | 781.7 | 742.7 |
| | | 55.9 | 542.5 | 256.6 | 53.7 | 477.1 | 480.2 |
| | 10 | 157.3 | 1415.1 | 444.6 | 214.5 | 855.6 | 752.8 |
| | | 39.3 | 543.4 | 164.8 | 63.5 | 414.6 | 309.8 |
| | 20 | 150.1 | 1537.7 | 555.6 | 288.2 | 906.8 | 828.4 |
| | | 31.9 | 282.9 | 139.4 | 131.1 | 238.8 | 273.3 |
| | 30 | 163.6 | 1447.3 | 632.5 | 349.4 | 954.7 | 843.1 |
| | | 34.5 | 370.9 | 100.4 | 153.3 | 149.1 | 186.8 |
| Sogang | 6 | 223.8 | 910.5 | 589.1 | 206.8 | 63.6 | 649.1 |
| | | 102.2 | 538.9 | 329.2 | 165.2 | 308.0 | (30.2.) |
| | 8 | 313.6 | 967.2 | 708.0 | 317.9 | 786.5 | 782.1 |
| | | 151.4 | 378.3 | 347.6 | 283.8 | 300.1 | 323.5 |
| | 10 | 235.3 | 970.4 | 632.9 | 182.8 | 747..3 | 676.7 |
| | | 109.4 | 342.5 | 306.8 | 194.2 | 281.0 | 233.3 |

TABLE 3

| | | Makespan | | | | | |
|---|---|---|---|---|---|---|---|
| Environment | #Robot | ORCA | APF | μNAV | RPF | APF-RS | APF-LS |
| Flat | 2 | 1033.6 | — | 522.8 | 679.9 | 499.5 | 532.3 |
| | | 177.3 | | 123.5 | 122.2 | 83.7 | 145.5 |
| Cylind | 2 | — | — | 501.0 | — | 825.2 | 838.1 |
| | | | | 62.7 | | 245.4 | 241.0 |
| Swap | 6 | 233.6 | 260.2 | 601.0 | 432.7 | 210.8 | 210.4 |
| | | 10.7 | 19.7 | 82.9 | 30.2 | 41.7 | 22.5 |
| | 8 | | 264.9 | — | 570.4 | 276.1 | 268.5 |
| | | | 20.0 | | 50.9 | 60.7 | 30.6 |
| | 10 | | 261.5 | — | — | 310.6 | 256.7 |
| | | | 19.8 | | | 72.6 | 29.4 |

TABLE 4

| | | Mean timestep | | | | | |
|---|---|---|---|---|---|---|---|
| Environment | #Robot | ORCA | APF | μNAV | RPF | APF-RS | APF-LS |
| Flat | 2 | 1027.3 | — | 490.8 | 648.8 | 494.0 | 512.9 |
| | | 187.9 | | 131.6 | 138.6 | 83.1 | 126.3 |
| Cylind | 2 | — | — | 472.2 | — | 784.4 | 785.4 |
| | | | | 82.1 | | 235.5 | 230.8 |
| Swap | 6 | 233.5 | 241.9 | 324.1 | 323.6 | 198.3 | 196.0 |
| | | 10.7 | 15.3 | 83.7 | 13.3 | 38.0 | 13.7 |
| | 8 | 357.6 | 241.3 | 287.0 | 382.6 | 245.8 | 238.9 |
| | | 64.1 | 17.2 | 94.5 | 17.5 | 64.7 | 20.7 |
| | 10 | 680.4 | 230.8 | 296.6 | 569.4 | 260.1 | 223.0 |
| | | 73.2 | 15.0 | 87.5 | 32.5 | 67.1 | 16.6 |

Referring to Table 1, Table 2, FIG. 24, FIG. 25, in the case of the Nakwon environment, it was confirmed that according to the APF-RS and APF-LS methods proposed in the present disclosure, the success rate was 60% or more in the experiment using maximum 10 robots, compared to the existing algorithm such as ORCA, μNav, and RPF having a low success rate of 15% or less. Compared to the existing algorithm of which the performance is rapidly deteriorated as the number of robots increases, it was confirmed that, according to the APR-RS and APF-LS methods, the arrival rate is 94.2% at minimum, so that the performance was improved by about 34% at maximum compared to the existing method.

Through this, it was confirmed that according to the proposed method, the target point was successfully reached by effectively solving the local minimum problem, even in the nonconvex obstacle environment. It was confirmed that the APF-RS and APF-LS provide stable performance even when relatively much more robots exist, and it was confirmed that there is possibility of expansion to a multiple-robot system in which multiple robots are disposed.

In the case of the Sogang environment, it was confirmed that, even in the complex environment having narrow corridors and small rooms, APF-LS recorded the success rate of 80% or more, and the success rate of APF-RS gradually decreases as the number of robots increases. Through this, it was confirmed that, when the LS method is applied, a problem possibly occurring in frequent interactions among multiple robots may be solved and efficient driving may be achieved.

Referring to Table 3, Table 4 and FIG. 26 to FIG. 28, in the case of the Flat environment, it was confirmed that APF-LS recorded a success rate higher than RS by 35%, and the ORCA and the APF showed very high failure rates due to deadlock. In particular, it was confirmed that APF-LS has successfully solved the problem that robots mis-recognizes each other as static obstacles.

In the case of the Cylind environment, it was confirmed that APF-LS recorded the success rate of 100% in the Cylind environment having nonconvex obstacles, whereas, all the existing methods failed due to deadlock.

In the case of the Swap environment, the key challenges were to solve the problem of the robots' mis-recognizing each other as static obstacles during the process of exchanging their positions and to avoid collisions. In this regard, APF-LS recorded the success rate of 100%. In contrast thereto, it was confirmed that according to ORCA and APF, the success rate significantly decreased as the number of robots increases.

As such, based on the above-described data, it has been proven that when the rule-based switching method and the learning-based switching method are combined and utilized in controlling the autonomous mobile robot, it provides a high success rate and stability in the complex environment than the conventional multiple-robot navigation algorithm.

It was confirmed that, by utilizing the learning-based switching method, the problem of the multiple robots' mis-recognizing each other as obstacles, which may occur in the multiple-robot interactions is solved, such that repetitive interference between robots may be minimized, and excellent performance may be obtained even in the nonconvex obstacle environment.

The present embodiment may be represented by functional block configurations and various steps. These function blocks may be implemented as various number of hardware and/or software configurations configured to execute specific functions. For example, embodiment may employ direct circuit configurations such as a memory, a processing, a logic, and a lookup table that are capable of executing various functions under the control of one or more microprocessors or another control apparatus.

Similar to that components may be executed by software programming or software elements, the present embodiment includes various algorithms implemented as a combination of data structures, processes, routines, or other programming configurations, and may be implemented as a programming or script language such as C, C++, Java, or assembler. Functional aspects may be implemented by an algorithm executed in one or more processors.

In addition, the present embodiment may employ the conventional art for electronic environment setting, signal processing, and/or data processing, or the like. Terms such as “mechanism”, “element”, “means”, “configuration” may be used in wide meanings, and are not limited to mechanical and physical configurations. The above term may include the meaning of a series of software processes (routines) in connection with a processor, etc.

Any examples or use of exemplary terms in this specification are intended merely to elaborate the present disclosure and do not limit the scope of the present disclosure. Additionally, one of ordinary skill in the art will recognize that various modifications, combinations, and changes may be made within the scope of the patent claims or their equivalents.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: the autonomous mobile robot
110: the sensing unit
120: processor
130: storage unit
140: driver
150: output unit

What is claimed is:

1. An autonomous mobile robot, comprising:
a storage unit configured to store data obtained while the autonomous mobile robot is being driven;
at least one sensing unit configured to measure data including a distance value while the autonomous mobile robot is being driven; and
a processor configured to control the autonomous mobile robot,
wherein the processor is configured to:
control the autonomous mobile robot to be driven according to a first mode in response to determining that an obstacle is recognized while the autonomous mobile robot is being driven; and
control the autonomous mobile robot to move by switching from the first mode to a second mode in response to determining that the autonomous mobile robot is disposed adjacent to a local minimum,
wherein a switching between the first mode and the second mode is controlled by a rule-based switching method based on data measured by the at least one sensing unit.

2. The autonomous mobile robot of claim 1, wherein the autonomous mobile robot operating in the first mode switches from the first mode to the second mode in response to determining that Equation 1 below is satisfied:
$$\vert {F}_{t o t} \vert \leq {f}_{thr} ; \qquad < Equation 1 >$$
where Fₜₒₜ of the Equation 1 means a weighted sum of an attractive force for attracting the autonomous mobile robot from a target point and a repulsive force for moving the autonomous mobile robot away from the obstacle to avoid collision, and fₜₕᵣ means a predetermined threshold value.

3. The autonomous mobile robot of claim 2, wherein the predetermined threshold value is half a longest distance value among distance values measured from the at least one sensing unit.

4. The autonomous mobile robot of claim 1, wherein, in the first mode, the autonomous mobile robot is driven while avoiding the obstacle by an attractive force for attracting the autonomous mobile robot from a target point and a repulsive force for moving the autonomous mobile robot away from the obstacle.

5. The autonomous mobile robot of claim 1, wherein, in response to determining that the obstacle is recognized while the autonomous mobile robot is being driven, a first mode, which is at least one of approaches using an artificial potential field (APF), a vector field histogram (VFH), a dynamic window approach (DWA), a Follow the Gap algorithm, or an artificial neural network, is performed.

6. The autonomous mobile robot of claim 1, wherein, in response to determining that the autonomous mobile robot operating in the first mode is disposed at the local minimum, the autonomous mobile robot is configured to:
switch from the first mode to the second mode and move along a wall of the obstacle;
perform exiting from the local minimum while searching an edge of the obstacle.

7. The autonomous mobile robot of claim 1, wherein, in response to determining that a rotation angle θᵣₒₜ of the autonomous mobile robot operating in the first mode deviates from 0°, the autonomous mobile robot switches to the second mode.

8. The autonomous mobile robot of claim 1, wherein the autonomous mobile robot is configured to measure a direction in which a point of a closest distance to a destination among data measured by the at least one sensing unit is located, determine a direction indicator I_{dir} of the autonomous mobile robot based on this, and perform the switching between the first mode and the second mode.

9. The autonomous mobile robot of claim 1, wherein the autonomous mobile robot operating in the second mode switches from the second mode to the first mode in response to determining that Equation 2 below is satisfied:
$$\vert {F}_{t o t} \vert > {f}_{thr} ; \qquad < Equation 2 >$$
Where Fₜₒₜ of the Equation 2 means a weighted sum of an attractive force for attracting the autonomous mobile robot from a target point and a repulsive force for moving the autonomous mobile robot away from the obstacle to avoid collision, and fₜₕᵣ means a predetermined threshold value.

10. The autonomous mobile robot of claim 9, wherein the first mode is performed by resetting a rotation angle θᵣₒₜ of the autonomous mobile robot to 0°.

11. The autonomous mobile robot of claim 1, wherein the autonomous mobile robot is configured to control the switching between the first mode and the second mode by combining a learning-based switching method using a neural network model learned based on expert demonstration data with the rule-based switching method.

12. The autonomous mobile robot of claim 11, wherein in the learning-based switching method, the switching between the first mode and the second mode is controlled by using a vision transformer (ViT)-based neural network.

13. The autonomous mobile robot of claim 11, wherein, in the learning-based switching method:
an observation vector, which is a combination of the distance value obtained from the at least one sensing unit and state information of the autonomous mobile robot, is input;
the observation vector is configured as time series data; and
the expert demonstration data is learned by processing the inputted observation vector as an input matrix through vision transformer-based patch embedding.

14. The autonomous mobile robot of claim 13, wherein, in the learning-based switching method, a feature vector extracted based on the vision transformer is input into an MLP classifier, so as to determine the switching between the first mode and the second mode.

15. The autonomous mobile robot of claim 11, wherein the learning-based switching method is performed by replacing a value determined by the rule-based switching method in response to determining that another autonomous mobile robot is disposed around the autonomous mobile robot.

16. An autonomous mobile robot, comprising:
a storage unit configured to store data obtained while the autonomous mobile robot is being driven;
at least one sensing unit configured to measure data including a distance value and state information of the autonomous mobile robot while the autonomous mobile robot is being driven; and
a processor configured to control the autonomous mobile robot,
wherein the processor is configured to:
control the autonomous mobile robot to be driven according to a first mode in response to determining that an obstacle is recognized while the autonomous mobile robot is being driven;
control the autonomous mobile robot to switch from the first mode to a second mode and exit the local minimum by moving along a wall in response to determining that the autonomous mobile robot operating in the first mode is disposed at a local minimum, and
wherein a switching between the first mode and the second mode is controlled by a learning-based switching method based on a pattern learned by using a vision transformer (ViT)-based neural network learned through expert demonstration data and data measured from the at least one sensing unit.

17. The autonomous mobile robot of claim 16, wherein:
the switching between the first mode and the second mode is controlled by a rule-based switching method in which the switching is determined based on whether the robot is disposed at the local minimum; and
the learning-based switching method is performed by replacing a value determined by the rule-based switching method in response to determining that another autonomous mobile robot is disposed around the autonomous mobile robot.

18. The autonomous mobile robot of claim 16, wherein the at least one sensing unit configured to obtain the state information of the autonomous mobile robot is configured to:
sense a first point (Hit Point; HP), which is a point at which the autonomous mobile robot has reached a state of being disposed at the local minimum in the first mode and unable to move forward, and a second point (Leave Point; LP), which is a point at which the autonomous mobile robot switches from the second mode to the first mode and store the first and second points in the storage unit;
control the autonomous mobile robot to not reach again a point that has been passed through, based on the state information stored in the storage unit.

19. The autonomous mobile robot of claim 18, wherein, in response to determining that the autonomous mobile robot is disposed at a point that is the same as the first point, a direction indicator of the autonomous mobile robot is controlled to have an opposite symbol, so that controlling the second mode to be performed in an opposite direction.

20. An autonomous mobile robot, comprising:
a storage unit configured to store data obtained while the autonomous mobile robot is being driven;
at least one sensing unit configured to measure data including a distance value while the autonomous mobile robot is being driven; and
a processor configured to control the autonomous mobile robot,
wherein the processor is configured to:
control the autonomous mobile robot to be driven according to a first mode in response to determining that an obstacle is recognized while the autonomous mobile robot is being driven;
control the autonomous mobile robot to switch to a second mode and exit the local minimum by moving along a wall in response to determining that the autonomous mobile robot operating in the first mode is disposed adjacent to a local minimum,
wherein a switching between the first mode and the second mode is controlled by combining a rule-based switching method configured to determine whether a magnitude of the total force of the autonomous mobile robot is smaller than or equal to a threshold value based on data measured by the at least one sensing unit and a learning-based switching method utilizing a pattern learned from a vision transformer (ViT)-based neural network model learned based on expert demonstration data, and
wherein the learning-based switching method is controlled to perform by replacing a value determined by the rule-based switching method in response to determining that another autonomous mobile robot is disposed around the autonomous mobile robot.
